(19) United States
(12) Patent Application Publication
(10) Pub. No.: US 2012/0140362 A1
(43) Pub. Date: Jun. 7, 2012

(54) Method of Operating a Heating Element for Underfloor Heating

(76) Inventors: Mathew Robins, Winnipeg (CA); Ryan Kwasnica, Winnipeg (CA); Gregory Gulyas, Winnipeg (CA)

(21) Appl. No.: 12/958,777

(22) Filed: Dec. 2, 2010

(51) Int. Cl. H02H 9/00

(52) U.S. Cl. 361/18

(57) ABSTRACT

A heating element includes two flexible plastics layers connected in overlying relationship with first and second conductors each running along the element between the layers the side edges with a row of printed conductive strips at right angles to the conductors. A grounding layer comprising a sheet of foil laminated to a carrier is laminated to the heating element. A reinforcing layer in the form of a bitumen anti-fracture membrane is applied on one surface and a reinforcing layer of a fiber reinforced material is applied on the opposite surface for engagement into a tile adhesive layer. A resistor is provided between the grounding layer and the ground terminal of a GFI or similar device for controlling the heating current so as to avoid false triggering of the GFI.

### BACKGROUND OF THE INVENTION

The arrangement described and claimed herein can be used in many different situations but is described in particular in relation to heating elements of the type typically used in under floor heating of tiled and other floors.

In US Application 200910266810 published Oct. 29, 2009 and corresponding PCT WO 2009/129595 by the present Applicants is disclosed a heating element includes two flexible plastics layers connected in overlying relationship with first and second conductors each running along the element between the layers the side edges with a row of printed conductive strips at right angles to the conductors. A grounding layer comprising a sheet of foil laminated to a carrier is laminated to the heating element. A reinforcing layer in the form of a bitumen anti-fracture membrane is applied on one surface and a reinforcing layer of a fiber reinforced material is applied on the opposite surface for engagement into a tile adhesive layer. First and second strips of an electrically insulating material are applied over the first and second conductors to define slots allowing insertion into the slots of respective clamp type terminals.

Electrical heating elements for use under floor are widely used. In one arrangement the heating element comprises a flexible, electrically insulated polyester coated element in the form of an elongate sheet formed of top and bottom overlying layers of a polyester material where the element consists of two electrodes or bus bars running parallel the length of the element between the layers along the side edges. A row of conductive ink strips are printed onto the top surface of the bottom one of one layer of the polyester at right angles to the electrodes, contacting the electrodes thereby setting up parallel electrical heating circuits across the elongate sheet. The electrodes applied on top of the printed conductive heating strips can be formed of tinned copper and may cover a printed layer of a silver ink applied onto the edges of the bottom layer. The printed heating conductors and the bus bars are covered by the top layer.

Examples are shown in WO 2008/063173 (Sea) assigned to Carbonic Heat Corp and published 29 May 2008, WO 2007/008734 (See) assigned to Carbonic Heat Corp and published 18 Jan. 2007 and in WO 01/65891 (Marstiller) assigned to Calorique Ltd and published 7 Sep. 2001.

In another arrangement the heating element comprises a continuous serpentine heating wire embedded in or carried by a scrim to form a layer which can be laid over a sub-floor with the wire as part of the layer.

Such heating elements are well known and widely used for many different end uses. One end use which is preferred but not the only end use with which the present application is concerned is that of heating tile or other floors where the heating element is located between the sub-floor and the covering material with the floor adhesive applied over the heating element. The element can also be used with other types of covering layer such as concrete.

One problem which has arisen with the arrangement of the present applicants identified above is that, when connected to a safety system such as a GFI or similar device, which is required for safety, triggering of the GFI has occurred extensively for reasons which have up to now been impossible to determine.

### SUMMARY OF THE INVENTION

It is one object of the invention to provide an improved electrical safety device.

According to the invention there is provided a combination comprising:

a powered electrical device including a load;

the device including first and second conductors supplying a current to the load;

the device including a ground conductor arranged adjacent the load and separated from the load by a separating dielectric material for receiving fault current from the load in the event of a failure in the separating dielectric material;

a power supply device having a first connection terminal and a second connection terminal for supplying a voltage for generating a current across the first and second conductors and a ground terminal for connection to the ground conductor;

the power supply device including a switch operable in response to a current at the ground terminal greater than a predetermined allowable value;

and a current limiting device arranged:

to reduce current flowing to the ground terminal from the ground conductor caused by current induced on the ground conductor from the load and or the conductors to a level less than said predetermined allowable value to avoid triggering the switch;

to maintain current flowing to the ground terminal from the ground conductor caused by current transmitted to the ground conductor from the load and or the conductors due to a fault to a level greater than said predetermined allowable value.

Preferably the current limiting device is a simple resistor which can operate satisfactorily. However other more complex devices can also be used.

This method is particularly applicable in an arrangement in which the first conductor is maintained at or close to a ground potential and an alternating voltage is applied to the second conductor. The alternating voltage can be of the order of 120V or of the order of 240V.

Preferably the current limiting device is arranged to maintain the current at less that 15 mA.

The arrangement is particularly useful in respect of a heating system where the load comprises a heating element defined by a flat sheet having a first surface and a second surface each of which is defined by an insulating material, a first conductor and a second conductor for connection thereacross of an electrical voltage and a conductive material extending between the first and second conductors and located between the first and second surfaces such that the voltage causes a current through the conductive material which generates heat substantially across the full extent of the sheet, wherein the ground conductor comprises a grounding layer laminated to the heating element and comprising a sheet of a conductive foil attached to the first surface of the flat sheet defining the heating element and a covering layer of an electrically insulating plastics material over the foil.

While the arrangement is particularly applicable to heating systems of this type where a large heating element is protected by an overlying grounding sheet, the problem is worldwide, in hospitals, computer rooms and long wiring runs such as theatres and banquet halls.

The GFCI or GFI systems work on the principle that current entering through the Hot lead will return through the Neutral similar principle and any difference between the currents is indicative of a fault. This is correct both for 120/240 VAC systems. Some new GFCI/GFI devices monitor current on the actual ground lead rather than differences in current flowing between the Hot and Neutral leads.

Thus in the present arrangement, by monitoring the current balance the device can trip a breaker if the current between the Hot and Neutral differs by more than 5 to 15 mA depending on the make of GFCI and its classification; up to 500 mA for some industrial and equipment protection. These arrangements are provided primarily for fire protection but also are used to prevent shock to persons contacting the equipment.

It has been found that the use of such devices with a heat mat with the applied grounding layer which is connected to ground causes the breaker to trip. This applies not only to the system manufactured by the present Assignees but to any floor heating system with an area which is sufficiently large that capacitive coupling between the heating elements and the grounding sheet will generate a leakage current sufficient to trip the GFI.

Investigation has determined that on a full circuit element a ground current is generated by induction due to capacitive coupling that exceeds the GFCI's trip point. This leakage ground current is due to the capacitance of the heating mat/ground shield combination. The largest component is capacitive coupling due to the 90 deg shift of AC voltage across the CLD device. To minimize the current flowing from the grounding sheet the system uses a current limiting device (CLD) which is a resistor to limit current to less than 5 mA.

This in no way affects the operation of the GFCI and does not slow the reaction time of the GFCI to more than one cycle so that at the point of tripping to breaking should still be at the reaction time of the GFCI

Thus the Current Limiting Device (CLD) is designed to limit the milliamps in the grounding path to avoid the nuisance tripping which can occur in grounding planar electrical surfaces. An impedance is introduced into the ground path and limits the current exiting the ground path.

As an example, the invention concerns a grounding sheet covering the top side of a planar heating mat. The heat mat consist of 2 bus bars separated by resistive elements in turn creating a resistive heating mat. For safety reasons a grounding sheet is laminated over the element separated by a thin plastic sheet. The grounding sheet provides an alternative path to ground for any punctures to the heat mat(s) elements.

On a 240 Vac mat where the voltage applied to both the first and second conductors varies, measured values on the grounding sheet are negligible, due to the symmetrical characteristics of the 240 Vac supply. A current limiting resistor is used to limit current flowing from the grounding sheet. By the use of this current limiting resistor false triggering of the GFCI or GFI as the case may be can be reduced and still have the safety provided by the grounding sheet and the current interrupter.

On a 120 Vac mat where one conductor is maintained at close to ground, the problem with the induced current is more noticeable triggering the GFCI or GFI as the case may be. The current limiting resistor keeps the current exiting the ground sheet from exceeding the GFCI's fault current (typically 15 mA), unless a fault occurs.

On a European circuit (230 to 0 Vac heating mat) the problem with the induced current/voltage is more noticeable triggering the RCD (Residual Current Device) used in European systems. The current limiting resistor keeps the current exiting the ground sheet from exceeding the RCD's fault current (typically 30 mA).

The introduction of the CLD in no way interferes with the protection the GFCI/GFI/RCD are meant to provide. Engineering tests showed that the GFCI/GFI/RCD trip immediately when a ground fault is introduced.

A resistor is the preferred device, however a capacitor/inductor or a combination of the devices can be used as long as the series impedance equals the required value.

Preferably the heating element comprises:

a first flexible electrically insulating plastics layer defining the first surface;

a second flexible electrically insulating plastics layer defining the second surface;

the layers being connected in overlying relationship to form an elongate sheet with inside surfaces and outside surfaces and overlying side edges;

the first and second conductors comprising respective ones of two continuous electrodes each running along the element between the layers each along a respective one of the side edges and arranged for connection across a supply of a voltage;

the conductive material defining a row of conductive strips applied at right angles to the electrodes, contacting the electrodes thereby setting up parallel electrical heating circuits across the elongate sheet such that the voltage generates a heating current in the strips.

Different types of planar heating element can be used. Paper can be used as the material on which the conductors and the printed ink is carried.

Preferably the conductive strips are printed conductive ink.

Preferably the first and second layers are polyester.

Preferably there is provided a second sheet of a conductive foil attached to the second surface of the heating element for retarding fire.

Preferably there is provided a reinforcing layer on one side of the heating element which comprises an anti-fracture membrane.

Preferably the anti-fracture membrane comprises a resilient elastomeric layer.

Preferably the elastomeric layer is bitumen.

Preferably the anti-fracture membrane defines a pressure sensitive adhesive surface on an outer surface thereof.

Preferably the pressure sensitive adhesive layer is covered by a release sheet which can be peeled away to expose the adhesive.

Preferably the anti-fracture membrane is translucent.

Preferably the heating element comprises:

a first flexible electrically insulating plastics layer defining the first surface;

a second flexible electrically insulating plastics layer defining the second surface;

the layers being connected in overlying relationship to form an elongate sheet with inside surfaces and outside surfaces and overlying side edges;

the first and second conductors comprising respective ones of two continuous electrodes each running along the element between the layers each along a respective one of the side edges and arranged for connection across a supply of a voltage;

a first strip of an electrically insulating material over the first conductor defining a first slot therebetween allowing insertion into the first slot of an electrical contact of a first terminal;

and a second strip of an electrically insulating material over the second conductor defining a second slot therebetween allowing insertion into the second slot of an electrical contact of a second terminal.

Preferably there is no adhesive between the strip and the conductor.

Preferably the contact is one jaw of a clamp which bites through the layers of insulating material to engage the conductor.

Preferably the first strip is wider than the second strip so as to provide a location to receive an electrical contact of a terminal for connection to a grounding layer.

Preferably the contact is one jaw of a clamp which bites through the layers of insulating material to engage the grounding layer.

Preferably including a reinforcing layer of a fiber reinforced material defining an outermost layer on the first side of the heating element, the fiber reinforced material defining a fibrous bonding layer for engagement into a tile adhesive layer.

Preferably the metal foil layer and covering layer of a plastics material are a pre-formed laminate applied as a common laminate onto the sheet forming the heating element.

Preferably the pre-formed laminate is laminated to the heating element by a laminating layer formed of a plastics sheet carrying on each side a layer of an adhesive.

Preferably the foil thickness is less than 0.001 inch.

### BRIEF DESCRIPTION OF THE DRAWINGS

One embodiment of the invention will now be described in conjunction with the accompanying drawings in which:

FIG. 1 is a cross section showing an end of one edge of a composite heating element for use with tile flooring of the type shown in the above published application of the present applicants.

FIG. 2 is a cross section showing the whole of the edge of FIG. 1.

FIG. 3 is an end elevational view similar to that of FIG. 2 showing the whole edge and showing the conductor clamps engaged with the first and second conductors and the grounding layer.

FIG. 4 is an exploded end elevational view similar to that of FIG. 3.

FIG. 5 is a top plan view showing the components of FIG. 1.

FIG. 6 is a schematic illustration showing the connection of a voltage supply to the heating element of the type described and illustrated above, and showing the arrangement of the present invention.

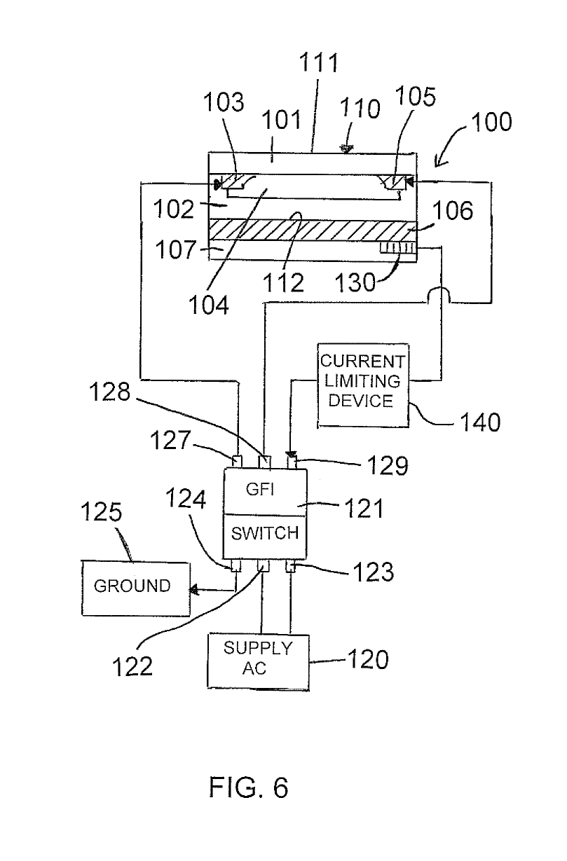

FIG. 7 is a further schematic illustration showing the arrangement of FIG. 6.

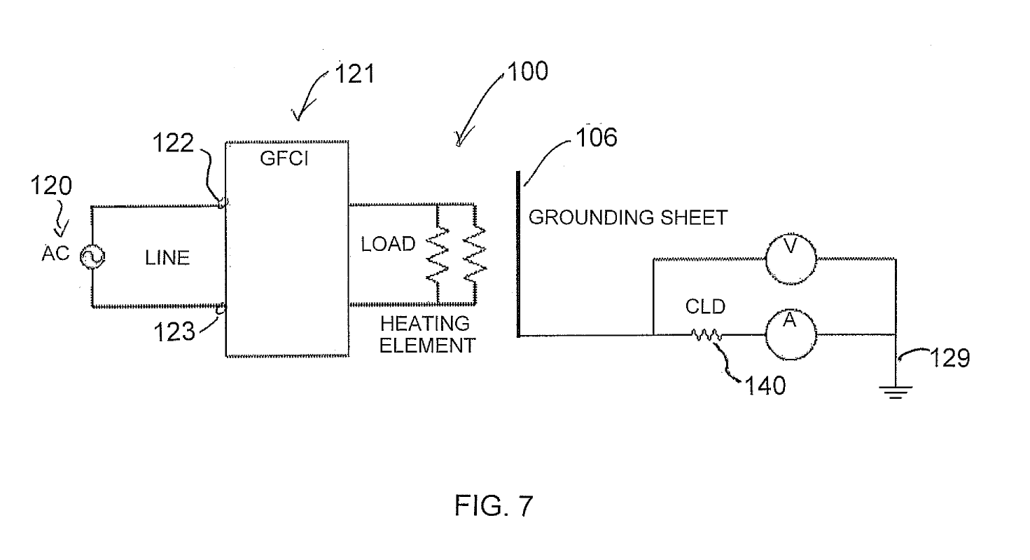

In the drawings like characters of reference indicate corresponding parts in the different figures.

### DETAILED DESCRIPTION

The following description is taken from the above published application of the present applicants.

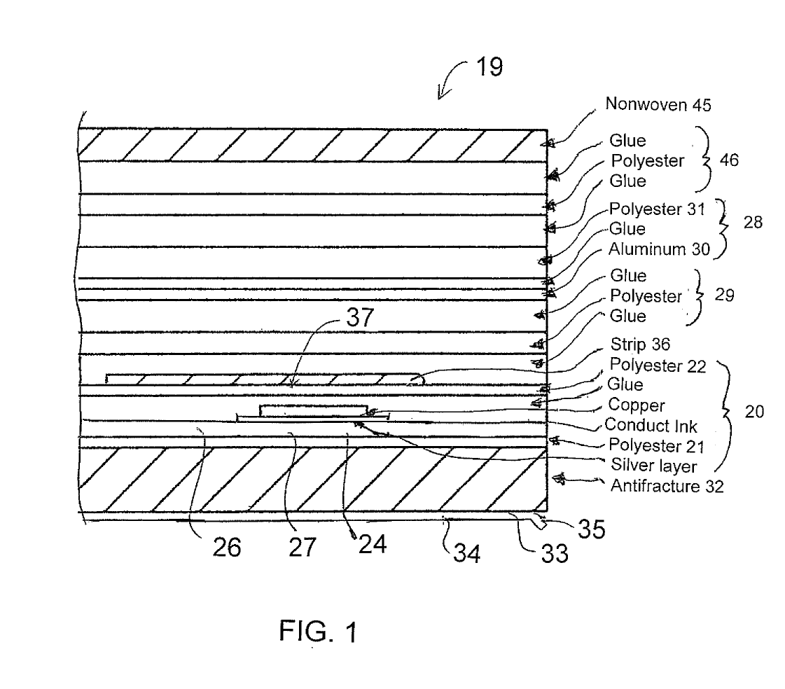

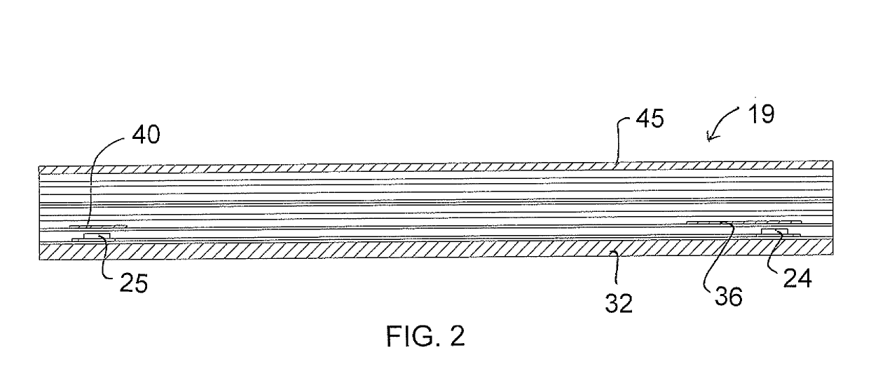

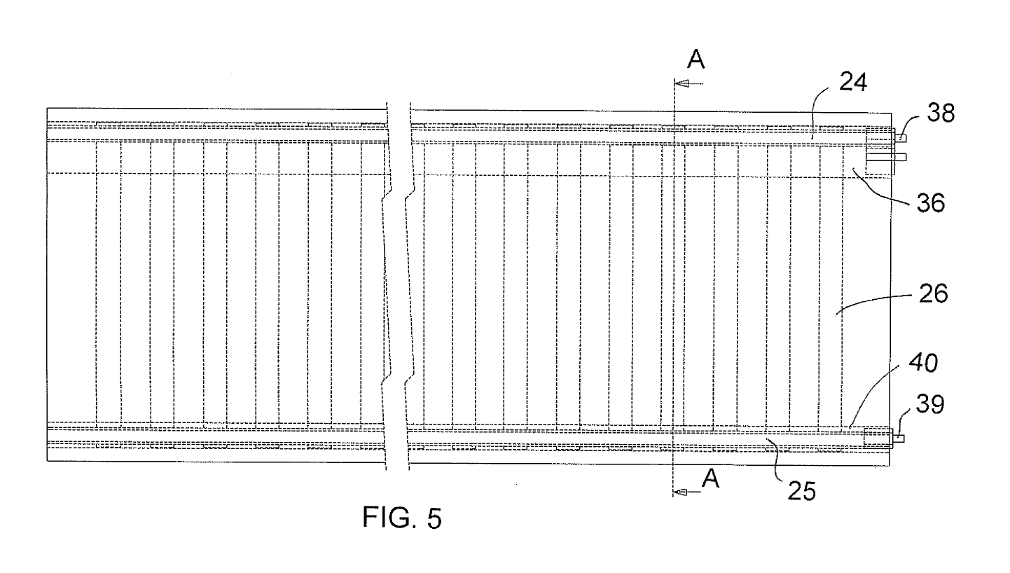

Turning firstly to FIGS. 1, 2 and 9 particularly, one example of a composite heating element 19 according to the present invention comprises a heating element 20 comprising a first flexible electrically insulating plastics layer 21 defining a first surface; a second flexible electrically insulating plastics layer 22 defining a second surface, the layers being connected in overlying relationship to form an elongate sheet with inside surfaces and outside surfaces and overlying side edges as shown in FIG. 5.

First and second conductors are defined by respective ones of two continuous electrodes 24 each running along the element between the layers each along a respective one of the side edges and arranged for connection across a supply of a voltage.

A conductive material extends between the first and second conductors and located between the first and second surfaces such that the voltage causes a current through the conductive material which generates heat substantially across the full extent of the sheet. The material is defined by a row of conductive strips formed by printed ink layer 26 applied at right angles to the electrodes, contacting the electrodes 24 and 25 thereby setting up parallel electrical heating circuits across the elongate sheet such that the voltage generates a heating current in the strips. A silver layer 27 is applied over the top of the printed ink to generate better contact to the bus bar or electrode 24.

A grounding layer 28 is laminated to the heating element by a laminating layer 29 and comprises a sheet of a conductive foil 30 pre-laminated to a covering layer 31 of an electrically insulating plastics material over the foil. The grounding layer 30 is laminated to the first surface 22 of the flat sheet defining the heating element 20 by the laminating layer 29 formed by a layer of plastics material carrying layers of laminating glue. Other laminating methods and materials can be used as known to persons skilled in this art.

The first and second conductors 24 and 25 comprise respective ones of two continuous copper electrodes each running along the element between the layers each along a respective one of the side edges and arranged for connection across a supply of a voltage. The first and second layers 21, 22 are polyester. There can be provided a second sheet of a conductive foil (not shown) attached to the second surface 21 of the heating element for retarding fire.

There is provided a reinforcing layer 31 on one side 21 which is the lower side of the heating element 20 which comprises an anti-fracture membrane formed of a resilient elastomeric layer such as bitumen.

The anti-fracture membrane 32 defines a pressure sensitive adhesive surface 33 on an outer surface thereof which is covered by a release sheet 34 which can be peeled away at 35 to expose the adhesive.

In an alternative arrangement, the anti-fracture membrane is translucent or at least can be seen through so as to make visible the conductive ink strips 26 so that a user can cut the element to length in a transverse direction while avoiding cutting through the strips 26.

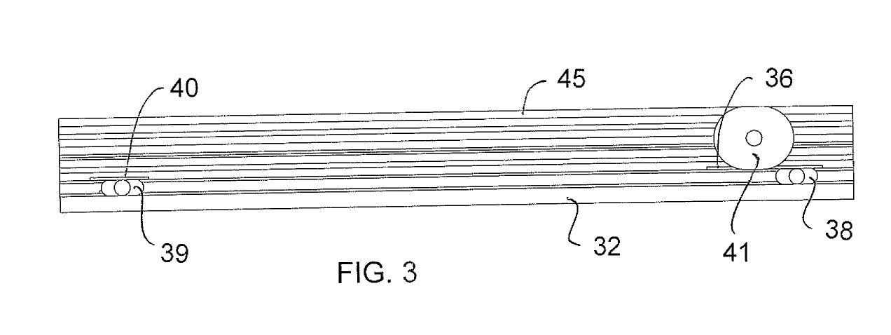

A first strip 36 of an electrically insulating material is applied over the first conductor defining a first slot 37 therebetween allowing insertion into the first slot of an electrical contact (FIG. 3, 4) of a first terminal 38;

A second strip 40 of an electrically insulating material over the second conductor defining a second slot therebetween allows insertion into the second slot of an electrical contact of a second terminal 39. The slots are formed simply by the expedient of providing no adhesive between the strip and the respective conductor. The contact is one jaw of a clamp which bites through the layers of insulating material to engage into the respective conductor.

The strip 36 is wider than the second strip 40 so as to provide a location to receive an electrical contact of a terminal 41 for connection to a grounding layer. The terminals are covered by an insulating cover as is required for electrical insulation of the installation.

Again the contact of the terminal 41 is one jaw of a clamp which bites through the layers of insulating material to engage the foil grounding layer 30. As the contact of the terminals 38 and 39 engages downwardly away from the grounding layer, they do not engage the grounding layer. As the terminal 41 is spaced along the strip 36 away from the contact 24, it does not engage the strip 24.

A reinforcing layer 45 of a fiber reinforced material is laminated by a laminating layer 46 so as to define an outermost layer on the first or upper side of the heating element, the fiber reinforced material defining a fibrous bonding layer for engagement into a tile adhesive layer.

The metal foil layer 30 and covering layer 31 of a plastics material are a pre-formed laminate applied as a common laminate onto the sheet forming the heating element with a foil thickness is less than 0.001 inch and preferably of the order of 0.00035 inch.

Thus the arrangement uses a thin gage aluminium of thickness only enough to carry the current to keep the costs down. This thin aluminium itself does not have the structural strength (tears/deforms easily) to be easily processed into our laminate structure.

The aluminium is already laminated to a polyester carrier sheet that provides all the structural strength for processing. The aluminium is anchored to the polyester using a dry cross-linked polyester based laminating adhesive. This structure is commonly used for shielding telecommunication cables.

The polyester on top and the heating element below also act as a barrier films preventing the aluminium from exposure to corrosive elements in all applications.

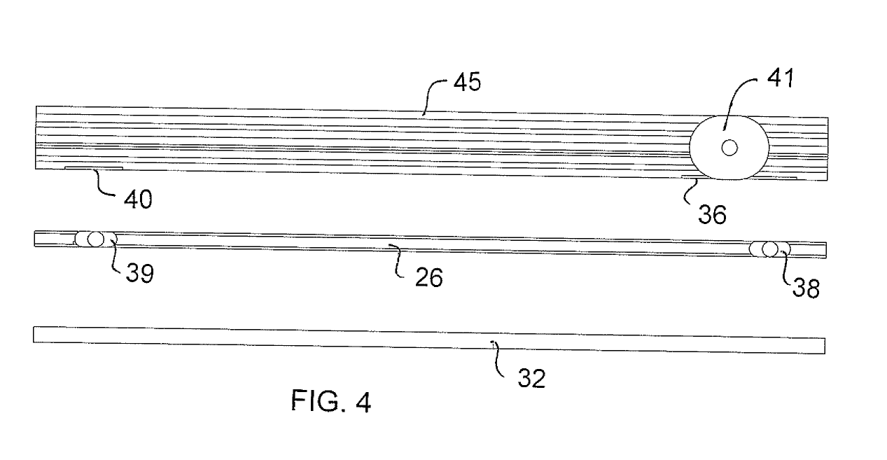

Referring to FIG. 4, as shown the terminal clips 38 and 39 must be attached to the assembly before adding the anti-fracture layer 32.

In an alternative arrangement (not shown) additional strips similar to the strips 36 and 40 are used to provide a similar non adhered spaces or slots similar to the slots previously described but located between the anti-fracture layer 32 and the bottom of the element 26 to attach the terminal clips 38 and 39. This allows the manufacturer to add the anti-fracture layer in line at the same time as other layers like layer 45.

The following examples of specific combinations of components are provided:

### EXAMPLE 1

```
Nonwoven PET Scrim
  19 umPE
  13 umPET
  19 umPE
  25 um PET Film
0.6 um PET Based Adhesive
  9 um Aluminum
  19 umPE
  13 um PET
  19 um PE
  51 um PET
  95 um PE
Copper Bus Bar
Conductive Ink
114 um PET
762 um Bitumen
```

### EXAMPLE 2

```
  25 um PET Film
0.6 um PET Based Adhesive
  9 um Aluminium
  19 um PE
  13 um PET
  19 um PE
  51 um PET
  95 um PE
Copper Bus Bar
Conductive Ink
114 um PET
```

### EXAMPLE 3

```
  25 um PET film
0.6 um PET Based Adhesive
  9 um Aluminium
  19 um PE
  23 um PET
  19 um PE
  51 um PET
  95 um PE
Copper Bus Bar
Conductive Ink
114 um PET
```

The Heating Element comprises a flexible, electrically insulated polyester coated element. The element consists of two electrodes or bus bars running parallel the length of the element. A conductive ink strip is printed onto the polyester at right angles to the electrodes, crossing the electrodes thereby setting up an electrical circuit. The conductive ink is resistive as per desired watts required per square foot (meter). Each bar of ink is calculated in resistance (Ohms) and is part of the heater. The entire element is covered by another electrically insulated polyester film.

While a third bus bar can be used to carry ground current in the event of a fault, this can be omitted in most circumstances since the current values which generate roughly 10 to 12 watts per square foot which is typical are insufficient to require the additional conductive material and the foil will suffice. The foil may be coated on both sides with a plastics insulating material (not shown) and in the event that the bus bar is not used, it is only necessary to connect to the ground layer at a single point by stripping the plastic coating layer on one side. The bus bar can be located underneath or on top of the foil. The top reinforcing layer of a woven or non-woven scrim can be of the type known as Collbond.

In a further embodiment (not shown) the top reinforcing layer of woven or non-woven scrim and the bottom anti-fracture membrane can be used in relation to a wire element type construction where the element is grounded with a grounding sheet or not grounded. The wire of the element is contained in a scrim.

A further example (not shown) includes a grounding layer and includes a second foil layer on the opposed side to the grounding layer for purposes of fire retardance.

The anti-fracture membrane may incorporate the heating element as part of the membrane or it may be separately applied depending on the manufacturer.

The arrangement can be used in a tiled floor comprising a sub-floor; a layer of tiles applied over the sub-floor; and a heating element where the reinforcing layer of a fiber reinforced material is on the upper side of the heating element and fastened to the layer of tiles by a tile adhesive and the anti-fracture membrane is on the bottom side of the heating element and fastened to the sub-floor.

Turning now to the present invention, the above arrangement of heating element is shown schematically at 100. The heating element 100 is defined by a flat sheet 110 having a first surface 111 and a second surface 112 each of which is defined by an insulating material. The insulating material is formed by two layers 101 and 102 of a plastics material which are laminated together as described above. Between the layers 101 and 102 is provide the electrical heating conductors defined by a first conductor 103 and a second conductor 105 for connection thereacross of an electrical voltage and a conductive material 104 extending between the first and second conductors 103, 105 and located between the first and second surfaces 111, 112. The voltage applied causes a current through the conductive material 104 which generates heat substantially across the full extent of the sheet 110.

As described above, a grounding layer 106, 107 is laminated to the heating element 110 and comprises a sheet of a conductive foil 106 attached to the first surface 112 of the flat sheet 110 defining the heating element 100 and a covering layer 107 of an electrically insulating plastics material over the foil.

The arrangement described above can include any or all of the constructions described above including the additional layers and the connections to the conductors.

The voltage across the conductors 103, 105 is provided from an AC supply 120 through a ground fault interrupter circuit 121. The circuit 121 is typically provided as a breaker in an electrical supply box with connections 122 and 123 to the AC voltage supply 120. In many cases the connection 122 is held at ground or neutral and the alternating voltage is supplied at the connector 123. A ground connection 125 is connected to a connector 124 of the GFI circuit.

The GFI Output provides terminals 127 and 128 which connects the voltage from the supply 120 to the conductors 103 and 105 to generate the heating current. The grounding layer 106 includes a terminal 130 which connects to an input connector 129 of the GFI. As is well known, the GFI circuit is responsive to current leaking to ground greater than a predetermined set value to switch off the supply of voltage to the connectors 127 and 128. The GFI also includes an over-current sensor to detect current through the connectors 127, 128 greater than a predetermined maximum to switch off the supply voltage.

Thus the supply 120 supplies a voltage for generating the heating current across the first and second conductors through a ground fault interrupter having a first terminal connected to the first conductor, a second terminal connected to the second conductor together with a ground terminal connected to the grounding layer and a switch operable in response to a current at the ground terminal greater than a predetermined allowable value;

A current limiting device 140 in the form of resistor is connected between the grounding layer 106 and the ground terminal 129 which has a resistance value which reduces current flowing to the ground terminal from the grounding layer caused by current induced on the grounding layer by the heating current to a level Less than said predetermined allowable value and which maintains current flowing to the ground terminal from the grounding layer caused by current transmitted to the grounding layer from the heating current due to a fault in the heating element to a level greater than said predetermined allowable value.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A combination comprising:
a powered electrical device including a load;
the device including first and second conductors supplying a current to the load;
the device including a ground conductor arranged adjacent the load and separated from the load by a separating dielectric material for receiving fault current from the load in the event of a failure in the separating dielectric material;
a power supply device having a first connection terminal and a second connection terminal for supplying a voltage for generating a current across the first and second conductors and a ground terminal for connection to the ground conductor;
the power supply device including a switch operable in response to a leakage of current to the ground conductor greater than a predetermined allowable value;
and a current limiting device arranged:
to reduce current flowing to the ground terminal from the ground conductor caused by current induced on the ground conductor from the load and or the conductors to a level less than said predetermined allowable value to avoid triggering the switch;
to maintain current flowing to the ground terminal from the ground conductor caused by current transmitted to the ground conductor from the load and or the conductors due to a fault to a level greater than said predetermined allowable value.

2. The combination according to claim 1 wherein the current limiting device is a simple resistor.

3. The combination according to claim 1 wherein the first conductor is maintained at or close to a ground potential and an alternating voltage is applied to the second conductor.

4. The combination according to claim 1 wherein the alternating voltage is of the order of 120V or of the order of 240V.

5. The combination according to claim 1 wherein the current limiting device is arranged to maintain the current at less that 5 mA.

6. The combination according to claim 1 wherein the load comprises a heating element defined by a flat sheet having a first surface and a second surface each of which is defined by an insulating material, a first conductor and a second conductor for connection thereacross of an electrical voltage and a conductive material extending between the first and second conductors and located between the first and second surfaces such that the voltage causes a current through the conductive material which generates heat substantially across the full extent of the sheet, wherein the ground conductor comprises a grounding layer laminated to the heating element and comprising a sheet of a conductive foil attached to the first surface of the flat sheet defining the heating element and a covering layer of an electrically insulating plastics material over the foil.

7. The combination according to claim 6 wherein the heating element comprises:
a first flexible electrically insulating plastics layer defining the first surface;
a second flexible electrically insulating plastics layer defining the second surface;
the layers being connected in overlying relationship to form an elongate sheet with inside surfaces and outside surfaces and overlying side edges;
the first and second conductors comprising respective ones of two continuous electrodes each running along the element between the layers each along a respective one of the side edges and arranged for connection across a supply of a voltage;
the conductive material defining a row of conductive strips applied at right angles to the electrodes, contacting the electrodes thereby setting up parallel electrical heating circuits across the elongate sheet such that the voltage generates a heating current in the strips.

8. The combination according to claim 6 wherein there is provided a reinforcing layer on one side of the heating element which comprises an anti-fracture membrane.

9. The combination according to claim 8 wherein the anti-fracture membrane comprises a resilient elastomeric layer.

10. The combination according to claim 8 wherein the anti-fracture membrane defines a pressure sensitive adhesive surface on an outer surface thereof.

11. The combination according to claim 10 wherein the pressure sensitive adhesive layer is covered by a release sheet which can be peeled away to expose the adhesive.

12. The combination according to claim 8 wherein the anti-fracture membrane is translucent.

13. The combination according to claim 6 wherein the heating element comprises:
a first flexible electrically insulating plastics layer defining the first surface;
a second flexible electrically insulating plastics layer defining the second surface;
the layers being connected in overlying relationship to form an elongate sheet with inside surfaces and outside surfaces and overlying side edges;
the first and second conductors comprising respective ones of two continuous electrodes each running along the element between the layers each along a respective one of the side edges and arranged for connection across a supply of a voltage;
a first strip of an electrically insulating material over the first conductor defining a first slot therebetween allowing insertion into the first slot of an electrical contact of a first terminal;
and a second strip of an electrically insulating material over the second conductor defining a second slot therebetween allowing insertion into the second slot of an electrical contact of a second terminal.

14. The combination according to according to claim 13 wherein there is no adhesive between the strip and the conductor.

15. The combination according to according to claim 13 wherein the contact is one jaw of a clamp which bites through the layers of insulating material to engage the conductor.

16. The combination according to according to claim 13 wherein the first strip is wider than the second strip so as to provide a location to receive an electrical contact of a terminal for connection to a grounding layer.

17. The combination according to according to claim 13 wherein the contact is one jaw of a clamp which bites through the layers of insulating material to engage the grounding layer.

18. The combination according to according to claim 13 including a reinforcing layer of a fiber reinforced material defining an outermost layer on the first side of the heating element, the fiber reinforced material defining a fibrous bonding layer for engagement into a tile adhesive layer.

19. The combination according to according to claim 6 wherein the conductive foil layer and covering layer of a plastics material are a pre-formed laminate applied as a common laminate onto the sheet forming the heating element.

20. The combination according to according to claim 18 wherein the pre-formed laminate is laminated to the heating element by a laminating layer formed of a plastics sheet carrying on each side a layer of an adhesive.

21. The combination according to according to claim 6 wherein the foil thickness is less than 0.001 inch.
